(19) United States
(12) Patent Application Publication
(10) Pub. No.: US 2004/0250529 A1
(43) Pub. Date: Dec. 16, 2004

(54) Gas turbine with intermittent combustion

(76) Inventor: Bernard Macarez, Lasseube (FR)

Correspondence Address: Marcarez Bernard, CD 324 Serre de Bourt, Quartier Labagnere, Lasseube, 64290, FR

(21) Appl. No.: 10/488,189

(22) PCT Filed: Aug. 29, 2002
(86) PCT No.: PCT/FR02/02956

(30) Foreign Application Priority Data
Sep. 7, 2001 (FR) 01/11601

(51) Int. Cl. F02K 9/00

(52) U.S. Cl. 60/225

(57) ABSTRACT

The pulse jet engine is a gas turbine characterized by an intermittent isochore combustion. The permanent flow of compressor output is pumped over in the form of gas bursts (pulses) towards the turbine stages after combustion has taken place in one or several units of three combustion chambers operating according to a three-phase cycle: intake, combustion, expansion. The throttle valves for opening and closing the chambers are controlled by electromagnets monitored by a digital system. The adjustment of the frequency of pulse productions and harmonization of the units enable the operating lines and variable permeability levels in the compressor field. The structural architecture is applicable to any type of aircraft engine, on land or at sea. For the same power level the pulse jet engine consumes less fuel, and the pumped over air flow is less than that of gas turbines.

This document describes the principle and the operating of a Pulse Combustion Engine (PCE), subject of the invention.

### 1. INTRODUCTION

During the last twenty years the gas turbines have tried in vain to overwhelm pistons engines for better specific fuel consumption. In these piston engines, the air intake, the compression, the combustion and the gas expansion occur in the same combustion chamber, which volume changes with the movement of the piston. This combustion operates partially at constant volume (isochore), partially at constant pressure and partially according to an isotherm at the end of the combustion during the gas expansion phase.

The Pulse Combustion Engine (PCE) discharge in turbine stages the gas at high temperature (about 2500° K.) and at high pressure (ex: 5000 Kpa to 6000 Kpa) obtained after a constant volume combustion (isochore). Operating at high pressure moves the cycle describes in the enthalpy-entropy diagram to the zones that reduce the relative increasing of entropy, (i/e at same area the diagram has more height but less width) thus improving the cycle efficiency and reducing the engine specific fuel consumption. The architecture of construction of the Pulse Combustion Engine (PCE) is possible in all kind of engines, air, land or marine application.

The (PCE) is an engine including single or multi stages compressor (axial or centrifugal) and single or multiple turbine stages (axial or radials: at action or reaction) of which:

Combustion operates at constant volume. Gas production at high temperature (about 2500 ° K.) and high pressure (ex: 5000 to 6000 Kpa).

turbines stages are fed by pulses of gas at high pressure, temperature and frequency

PCE doesn't need more cooling than conventional gas turbines as material meet alternatively hot gas flow and cool gas flow at a frequency consistent with material averaged thermal capacities and a steady-state thermal flow.

PCE architecture of construction is similar to the conventional gas turbine, and can be used in any kind of application, air, land and marine.

At same power, (PCE)'specific fuel consumption and air mass flow are less (about twice) than those of the conventional gas turbine.

### 2. PULSE COMBUSTION ENGINE (PCE)

### 2.1. DESCRIPTION—OPERATING PRINCIPLE

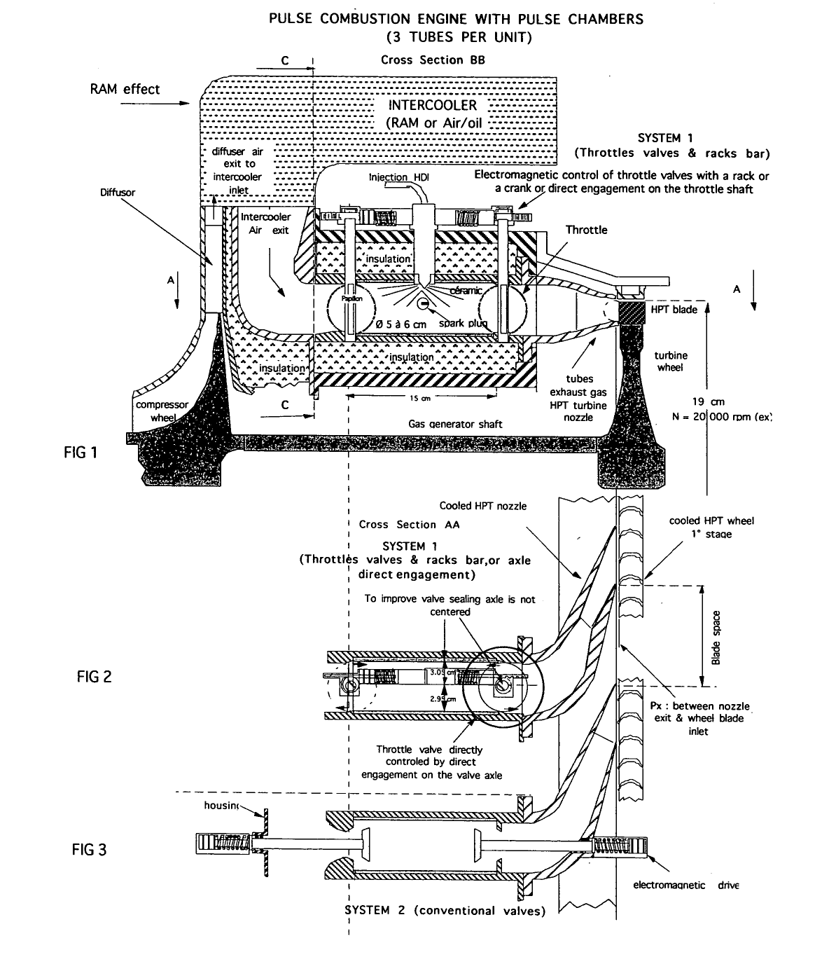

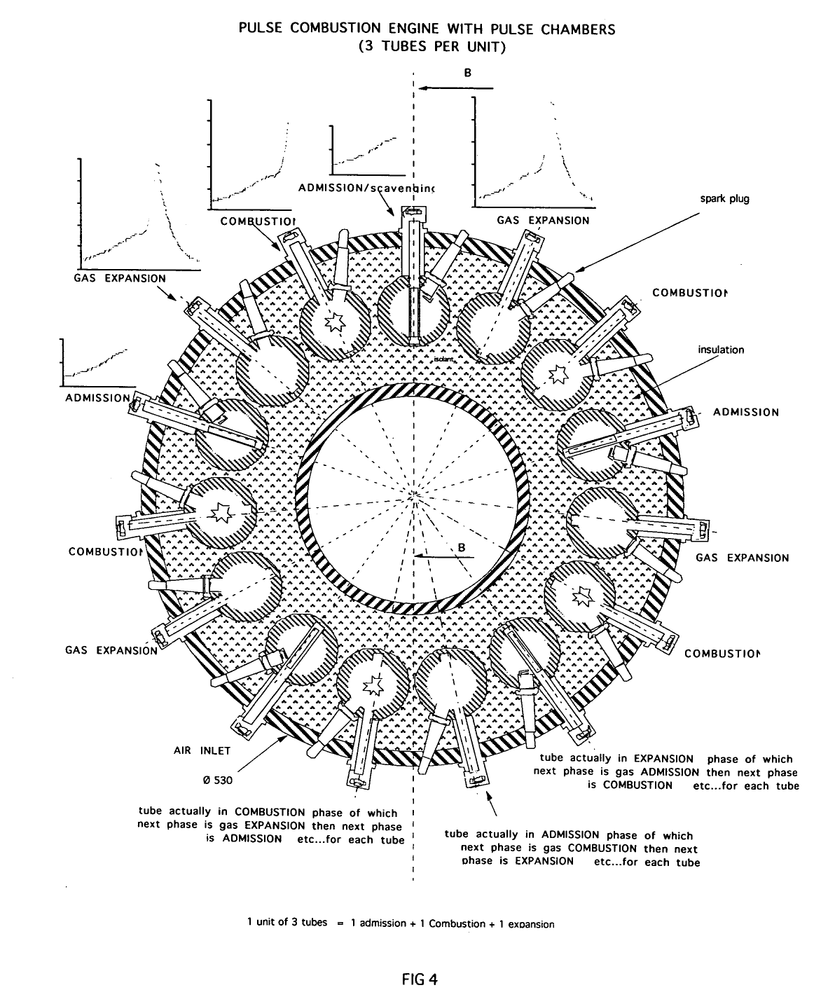

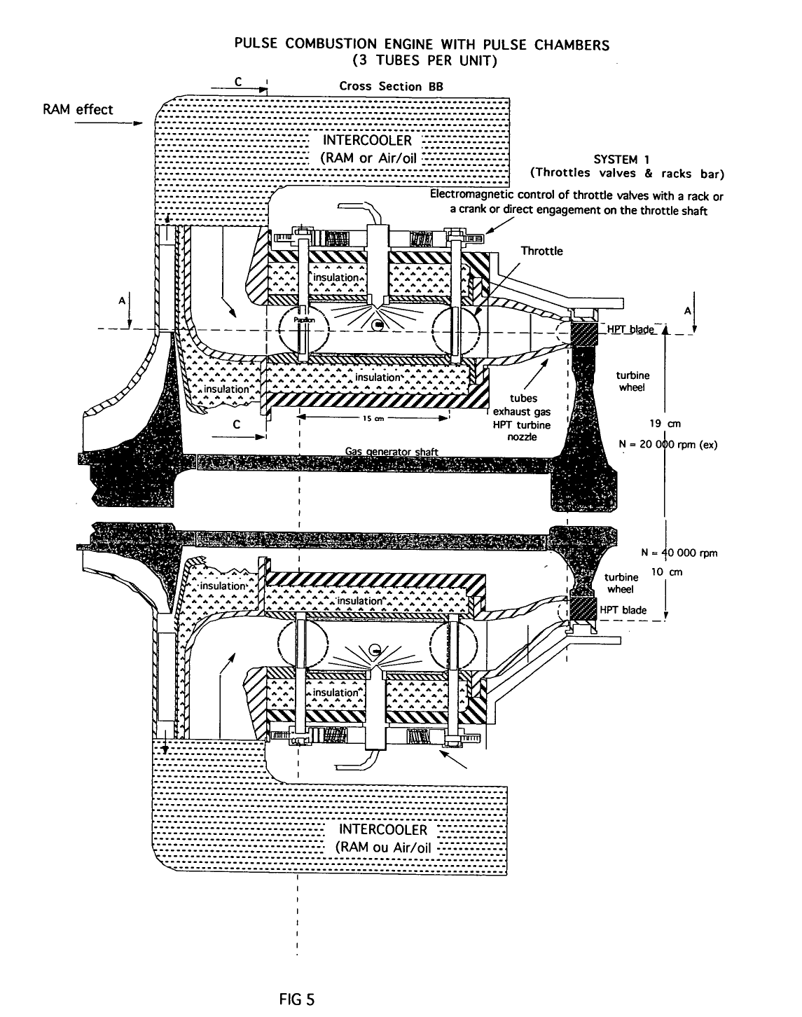

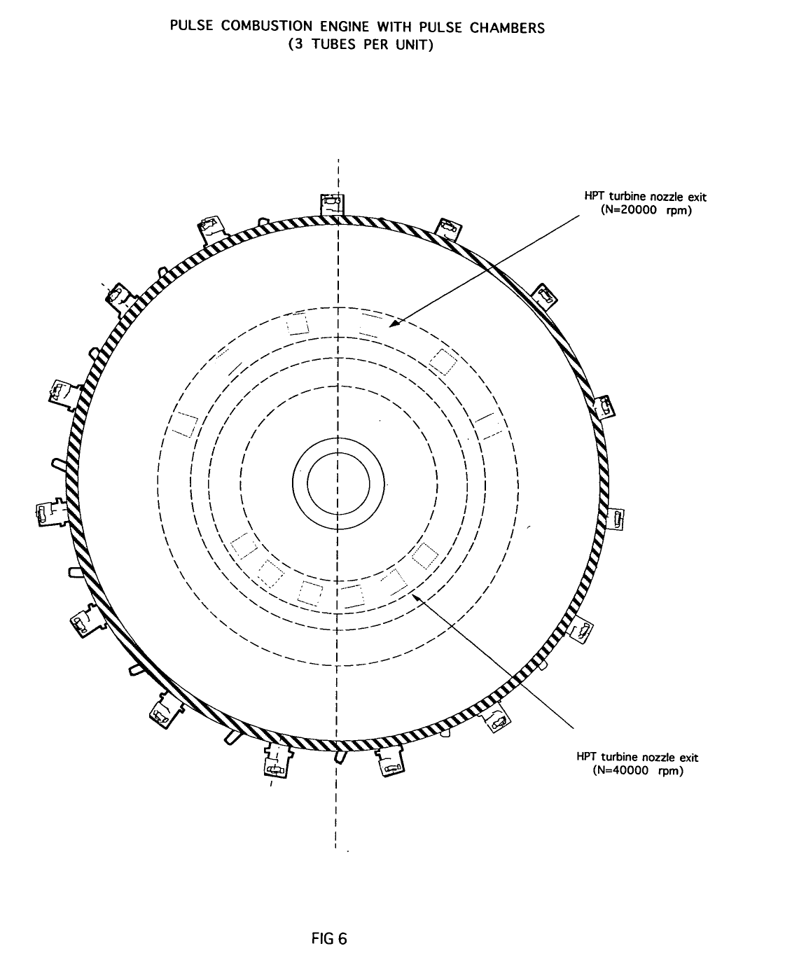

The FIGS. 1 to 8 herewith enclosed represent the drawings of the PCE (Pulse Combustion Engine) for 2 rotational shaft speeds; 20 000 RPM and 40 000 RPM (FIG. 5).

The PCE requires at least 3 identical chambers but in practice it is equipped with several units of several chambers (3.6 . . . 15, 18 chambers etc.) All chambers are identical whatever is their number. In every unit every chamber operates according to the following 3 phase-cycle: air intake, combustion, gas expansion in this order at the frequency fx

The operating frequency fx is equal to the opposite of the total period of time Tₓ

Tₓ=air intake time+combustion time+gas expansion time=1/fₓ

T_{adm}=time to feed the chamber with air=1/f_{adm}

T_{com}=combustion time in the chamber

T_{det}=time to expand the gas from the chambers to the turbine stages.

For 1 unit of 3 chambers we have successively and concomitantly the following situations

| | |
|---|---|
| The chamber 1 is in phase The chamber 2 is in phase The chamber 3 is in phase The chamber 1 is in phase And so on for every unit | 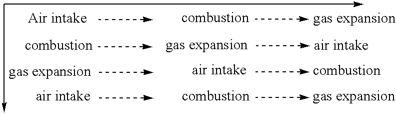 |

Several units of chambers allow various harmonization's (time lag of tubes openings/closings in-units of chambers one relative to the others) referring to various flow function of the compressor and so referring to various operating lines in the compressor map. The permanent air mass flow getting out of the compressor is changed after the combustion have taken in hot gas pulses discharged to the turbine stages. The principle is making turn phases of the cycle (air intake, combustion and gas expansion) in static chambers (tubes) with a determined frequency (fx=50 to 150 Hz) in one hand and in the other hand to manage the chambers opening time units so that the compressor “Sees” always simultaneously one or several chambers open in air intake phase, in order to keep an acceptable compressor surge margin.

The only elements in movement are the mechanisms of quick opening and closing of the chambers (valves/butterfly valves).

### 2.2. TIME CHARACTERISTICS

A pistons engine operating at 5000 RPM effects 1 revolution in about 12 ms (0.012 sec), the opening and closing time of the valves (inlet or exhaust) are very low (about 2 ms). For this type of engine the combustion takes place between −10° before PMH and +40° after PMH. (PMH=Top End Stroke) or 50°, or still about 1,7 ms.

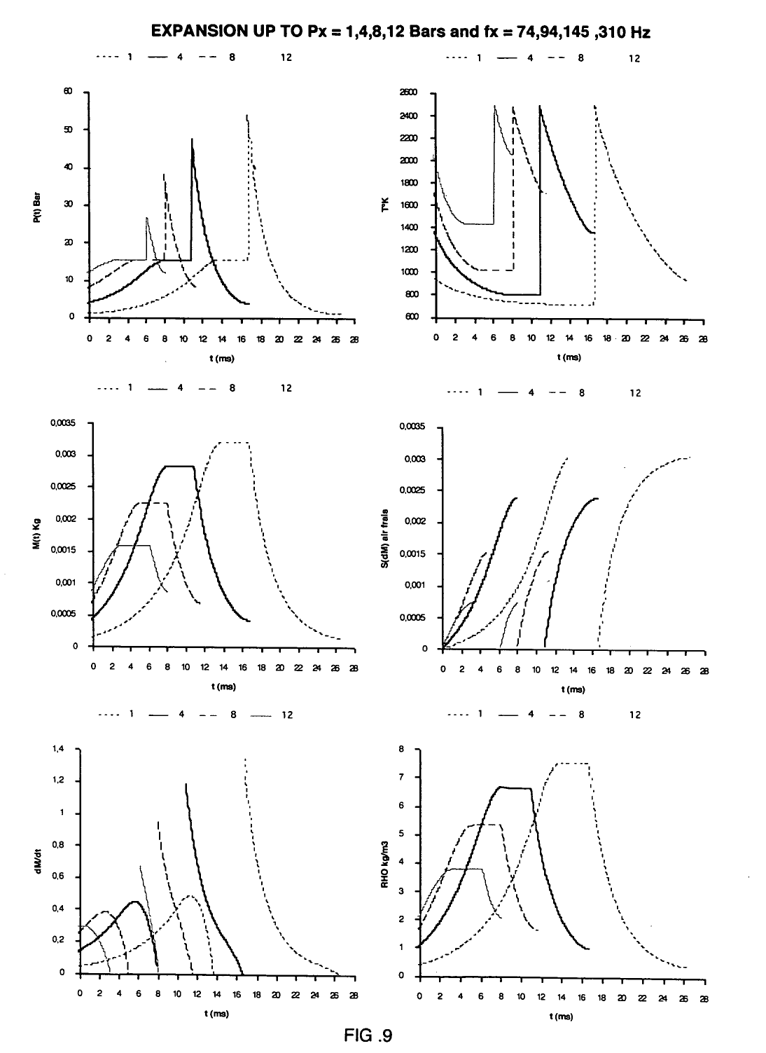

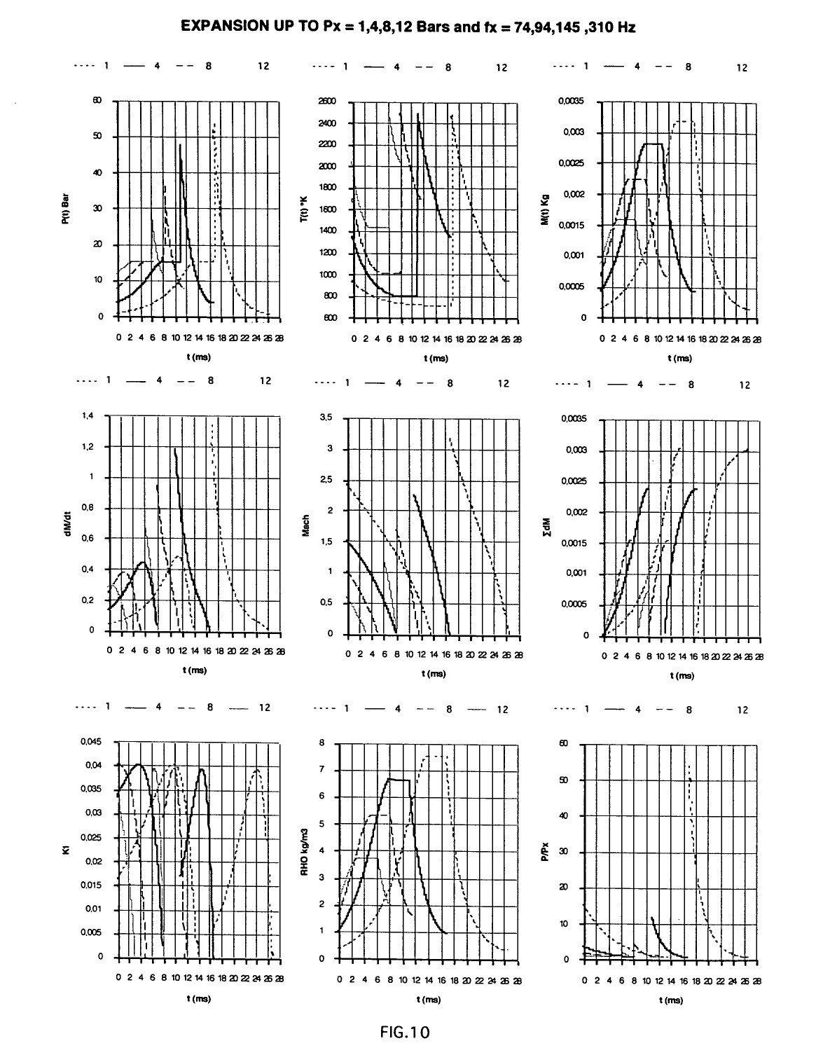

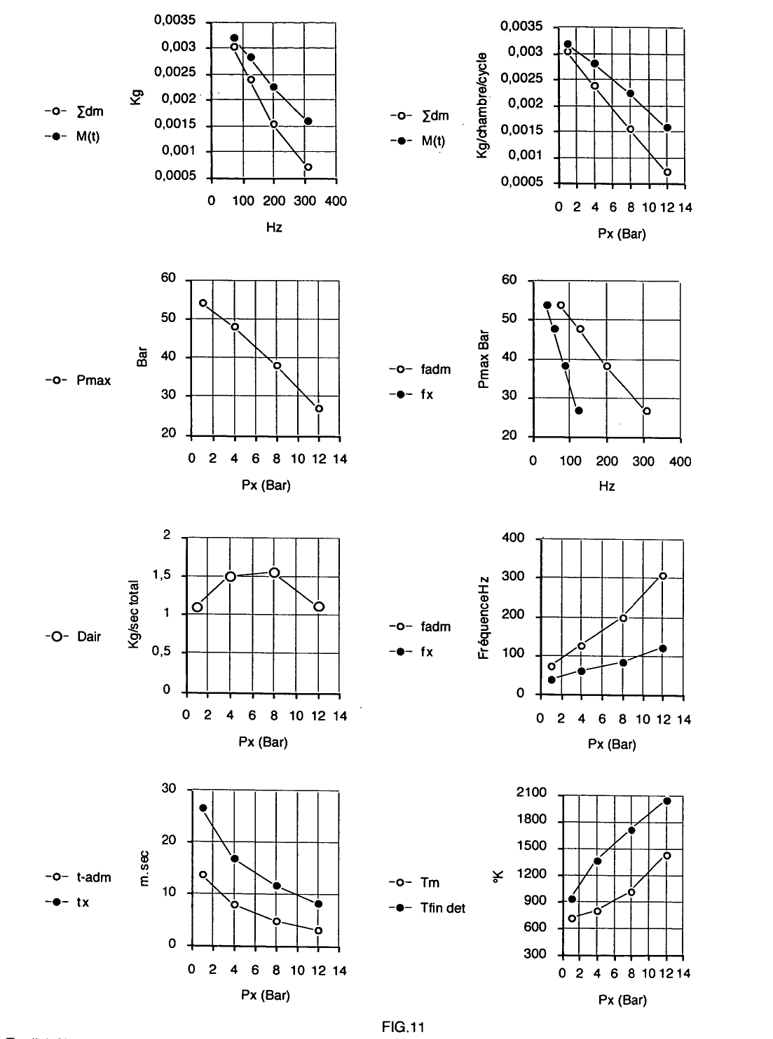

The valves opening and closing time of the PCE's chambers are about 2 to 3 milliseconds. In our estimated performances (FIGS. 9 to 10) we supposed that the time of combustion with closed valves is about 3 ms. The annex and the diagram herewith enclosed give a first approximation of times characteristic of filling (air intake phase) and emptying (exhaust/expansion phase) the chambers and also the resulting frequencies fₓ. Obviously, in order to size correctly the chambers it is necessary to perform calculation using laws of combustion heat release and turbulent unsteady state wall thermal exchange models. Those are today available in pistons engine makers (example: law of Vibe and Woschny). Nevertheless this is not necessary for a first estimated calculation of the cycle frequency fₓ.

### 2.3 FREQUENCY FX AND PRESSURE PX

For a maximal pressure obtained in the combustion chamber (example: 5500 Kpa for a compressor pressure ratio of P/P=15.5/1) the time of emptying the chamber depends on the level of the static pressure Pₓ located at the nozzle exit of the HPT (High Pressure Turbine) when the nozzle is choked. This first stage turbine nozzle is at the exit of the chamber._(Pₓ static pressure field located between the exit of the first stage turbine Nozzle and the turbine wheel inlet).

The mass of fresh admissible air in the chamber depends on the residual mass of non-expanded gas left in this chamber. This residual mass of gas depends on the time of gas expansion and therefore on the pressure Pₓ. The longer the gas expansion last, the smaller is the residual mass of gas in the chamber after gas expansion. For a given volume V of a chamber, the maximal pressure at the end of combustion will be as much high as the mass of air and therefore the mass of admissible fuel will be important. For a given compressor air pressure ratio the PCE will be as much performing as the chambers will be able to get empty quickly (quick and complete gas expansion). Consequently it is necessary to reduce all kind of losses which could be opposed to this gas expansion. During steady state operation a pressure Pₓ (averaged or un-stationary) will build up between the nozzle exit of the first stage turbine stage and the entry of the first turbine wheel and will regulate the process. When the frequency fₓ will increase, the average pressure Pₓ should increase too and therefore increase the residual mass of gas in the combustion chambers. This will reduce the admissible mass of fresh air and so will reduce the available power. We have to research the operating optimum that is the Pₓ, which authorizes the maximum air mass flow.

The pressure Pₓ is an experimental data, which is not easy to evaluate with a simple calculation. The calculations have been made with different hypothesis of the field static pressure Pₓ(1,4,8 and 12 Bars: 1 bar=100 Kpa) that gave calculated frequencies of 74, 94, 145 and 310 Hz (with the hypothesis of a time of combustion Tcomb=3 ms)(FIGS. 9 and 10).

### 2.4 HARMONIZATION

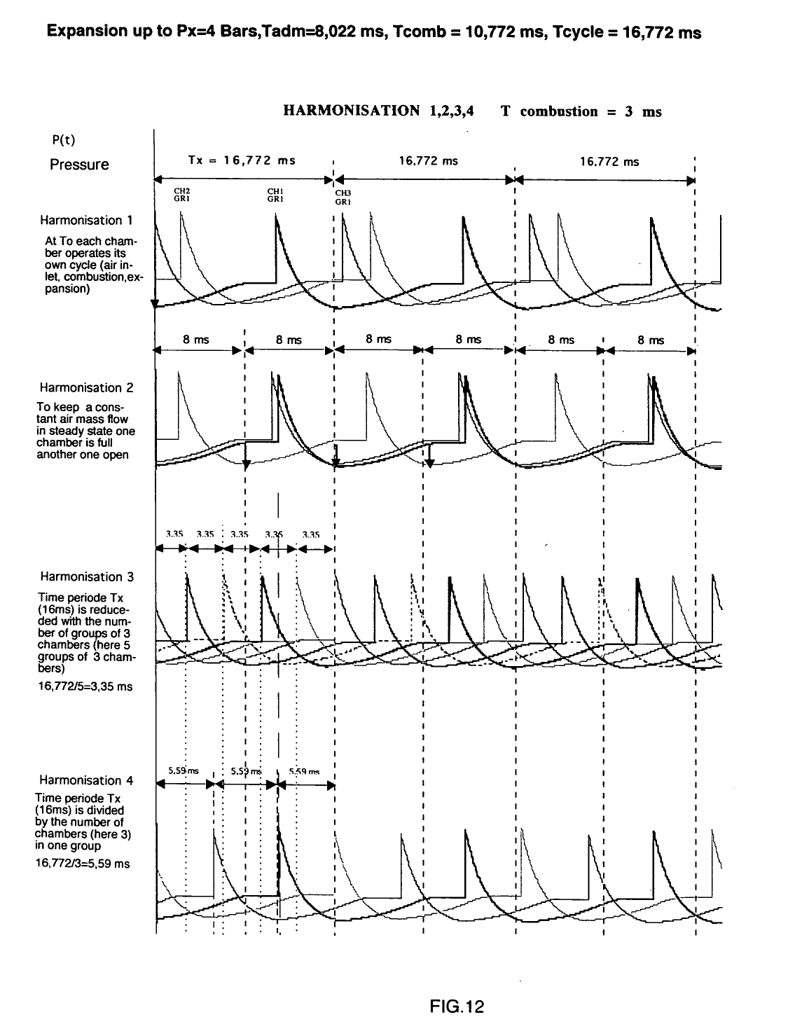

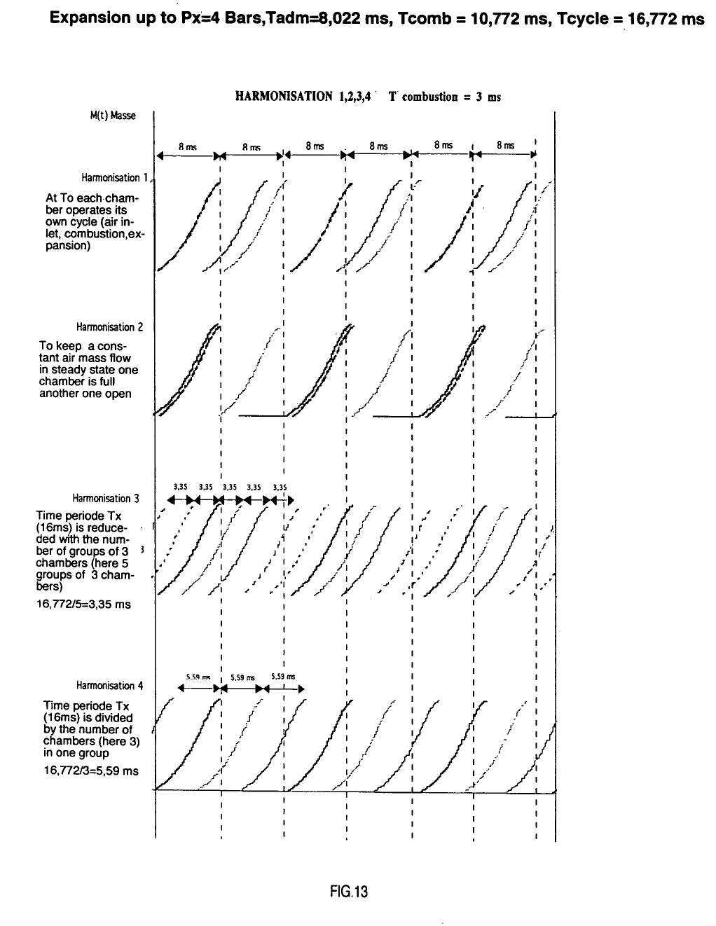

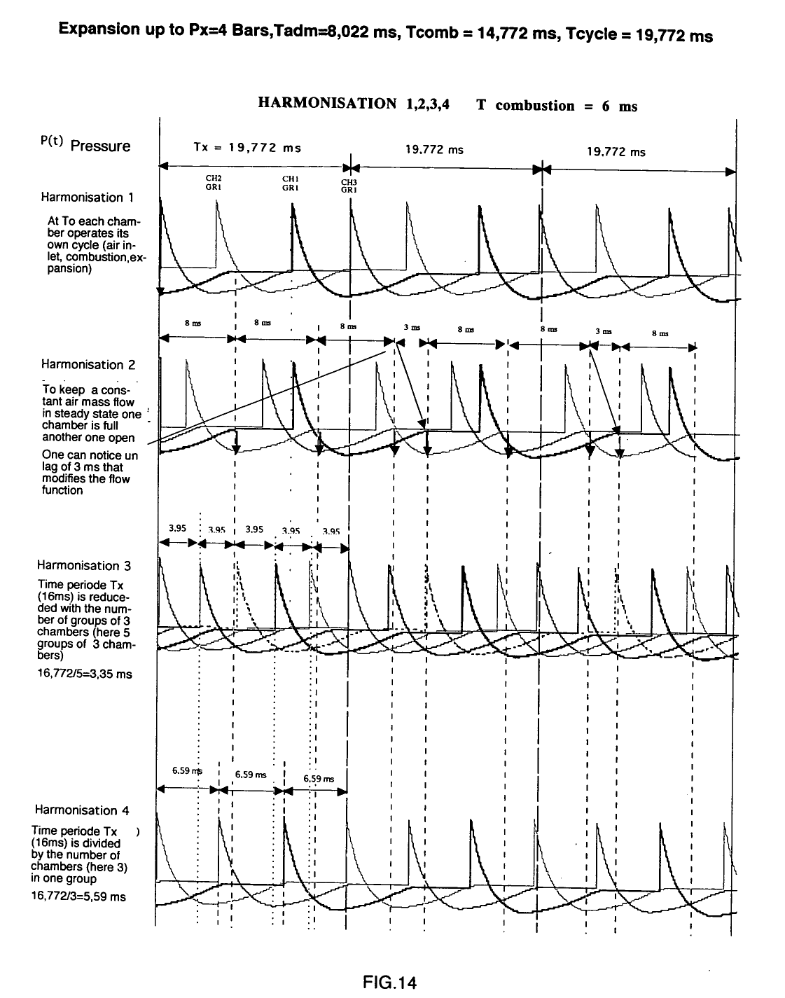

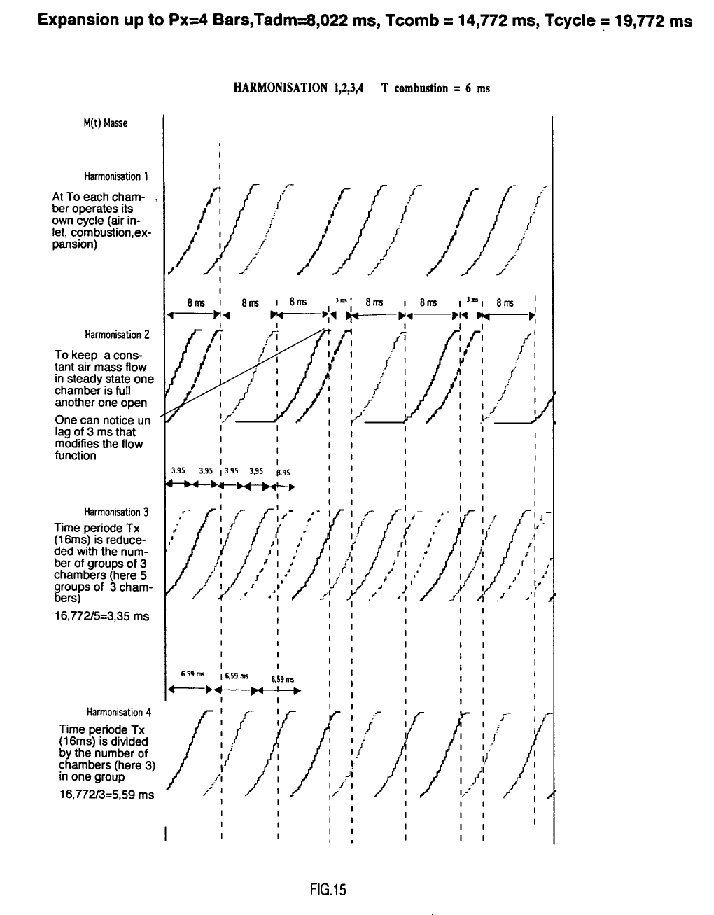

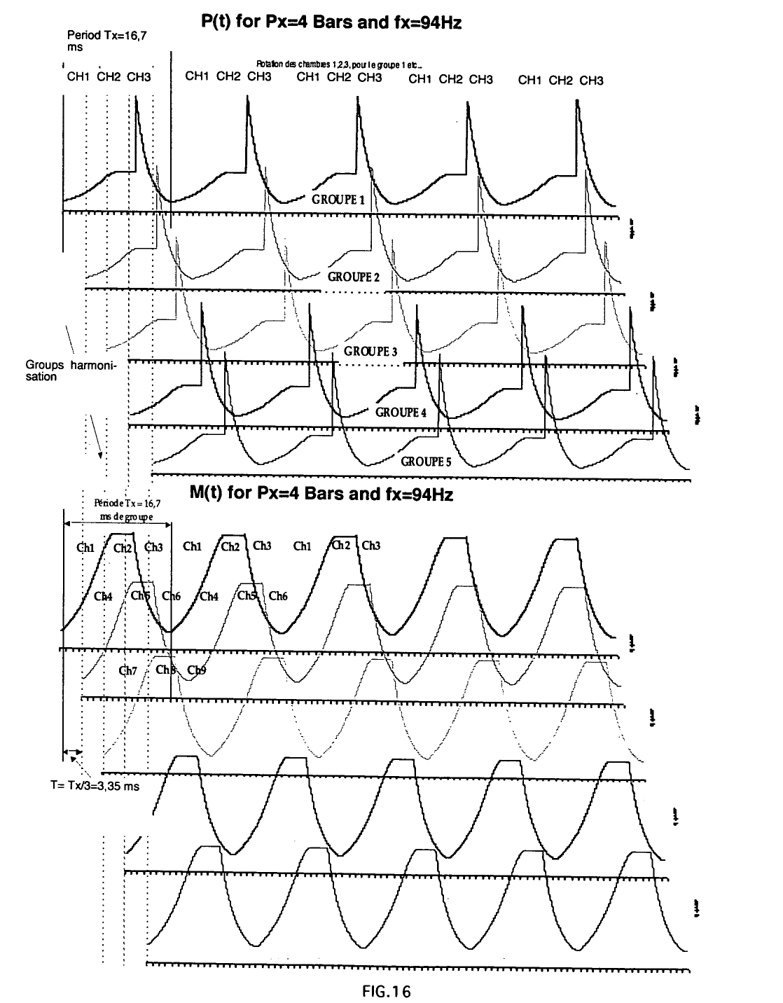

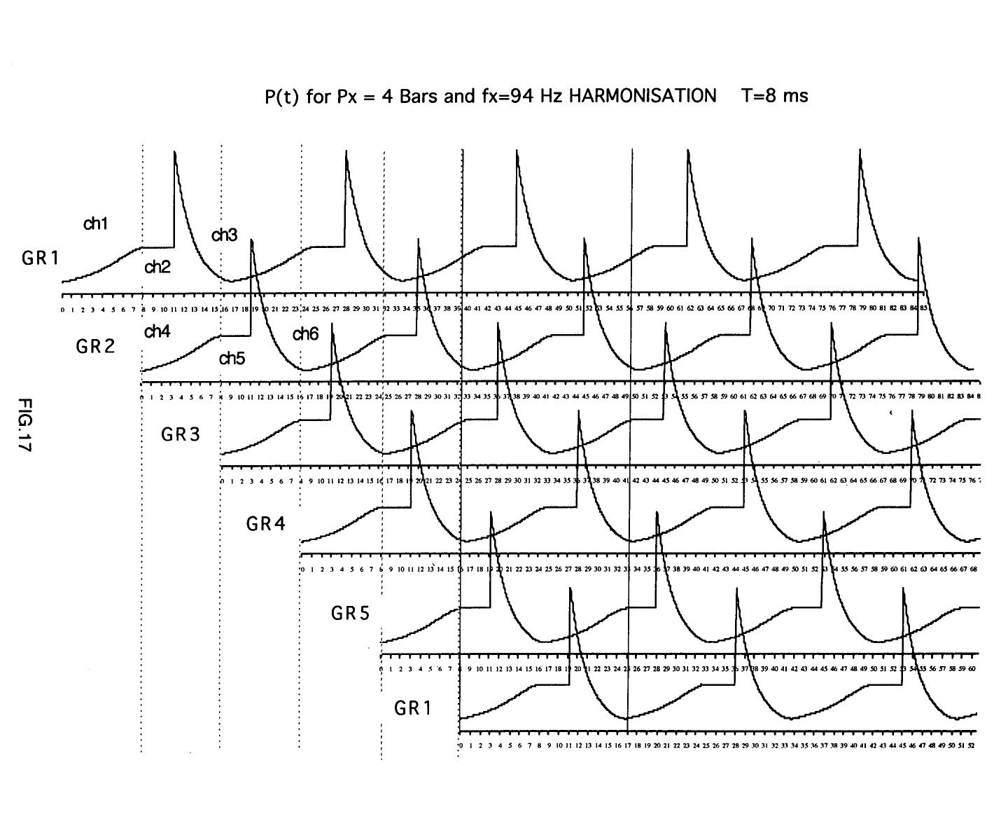

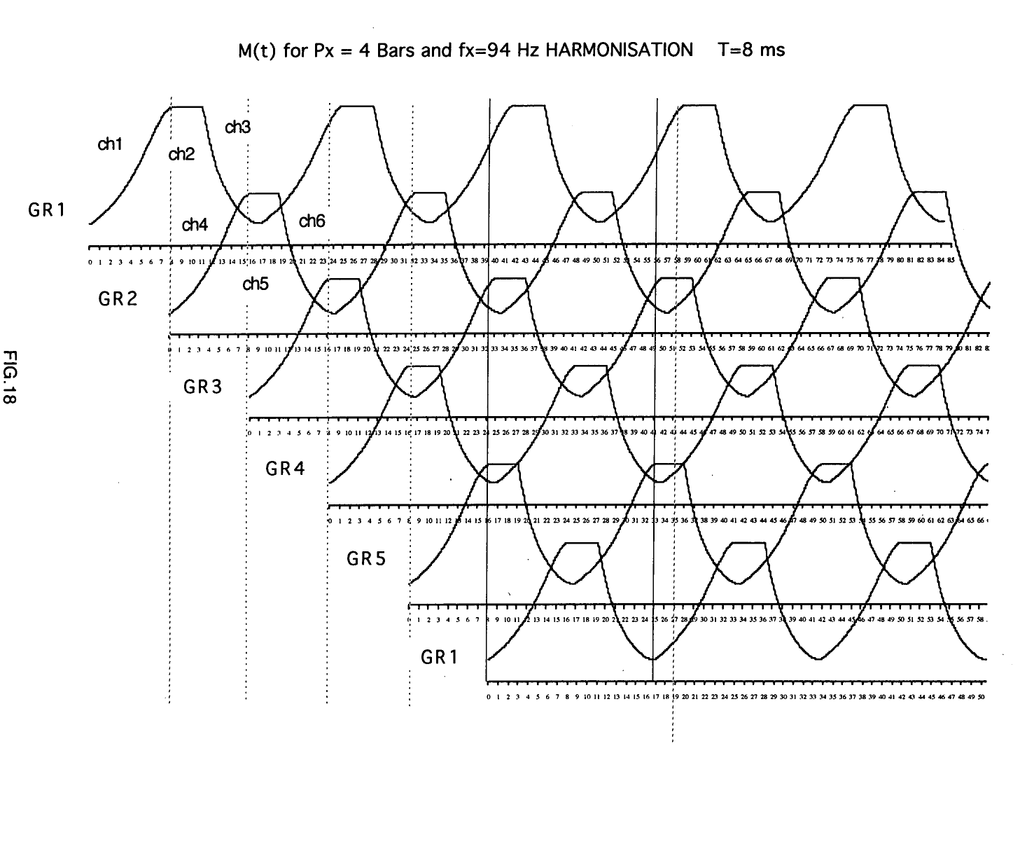

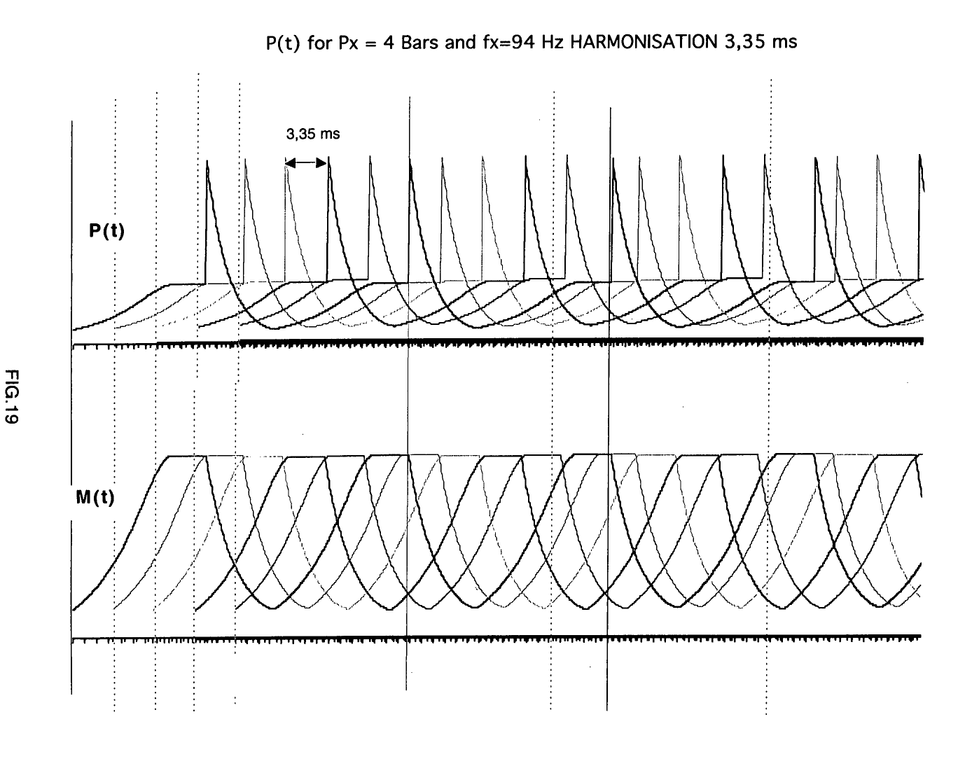

It is possible to “harmonize” the functioning of several units of 3 chambers in different ways (see FIGS. 12 to 19). With several units of 3 chambers to allow that the air mass flow leaving the compressor remains constant, the opening of a chamber is harmonized in such a way that at least one chamber of one unit at air intake phase opens as early as a precedent chamber of the same unit (or of another unit) also at air intake phase closes. This means the permeability or the compressor map operating line is controlled, but various flow functions are possible.

### 2.4.1 HARMONIZATION 1

Every chamber of a unit operates its own cycle in beginning with one of the phase's air intake/combustion/gas expansion. This can drive to a variable flow function and operating line fluctuates. A lag can set up between the opening of units of chambers. If the rate of functioning is Px=4 bars (400 Kpa), an opening of the chamber is for example possible every 8 ms.

### 2.4.2 HARMONIZATION 2

When a chamber of the unit 1 is feeded, another from the unit 2 or 3 opens (we try to situate this chamber the most distant possible from the first one). This harmonization is near to the precedent but we accept to delay the opening of the chamber at the end of combustion for example in order to avoid air intake/gas expansion phase at same time and at same location. The chamber will have finished its combustion but will be kept closed longer than necessary. This harmonization gives also a kind of fluctuated operating line.

### 2.4.3. HARMONIZATION 3

The period Tₓ=1/fₓ is divided by the number of units (here 5) and an opening of the chamber is imposed (with a management at 180°) every T_{x/}5 time period. For example at Px=4 bars (400 Kpa) it means that an air intake chamber is opened every 3.35 ms.

### 2.4.4. HARMONIZATION 4

The period Tx=1/fx is divided by the number of chamber in each unit (here 3) and an opening of the chamber is imposed (without a management at 180°) every Tx/3 time period. For example at Px=4 bars (400 Kpa) it means that an air intake chamber is opened every 5.59 ms. In these conditions every unit is independent and we open the air intake valve of the chamber of the same unit which has finished the gas expansion (this means Px=4 bars (400 Kpa) in our example) while the chamber of the same unit at end of combustion begin the gas expansion. This harmonization enables to operate at idle with a restricted number of units, while the others are inactive.

### 2.5 CONTROL SYSTEM

The system is monitored from data of pressure measured at combustion chamber inlet and exit (ideally the measure of Px). The aim is to optimizes the opening and closing of the butterfly valves in order to get the maximum pressure at every cycle as most as possible. That means the mass quantity of introduced air will be maximal (we note here the advantage of an inter-cooler placed between the compressor exit and the chamber inlet). The fuel mass flow will be adjusted according to the mass of air introduced in the chamber in order to have a fuel/air ratio closed to the stoechiometric combustion. For every unit of 3 chambers, there are simultaneously a chamber in air intake phase (INOP—Inlet open, Exit closed—EXCL), the second chamber (INCL, EXCL) and the third (INCL, EXOP). We can imagine a cooling phase of air scavenged through the chamber (INOP, EXOP).

This has to be verified during the experimentation and development phase because there is a risk of reverse flow (gas to air) if the pressure Px is not sufficiently relaxed (below the pressure of the compressor exit pressure).

### 2.6 OPERATING IN THE COMPRESSOR MAP (OPERATING LINE)

The time of closing of the anti-surge valves of today's compressor is about 200 to 300 milliseconds. This represents several PCE cycles of air intake, combustion, and gas expansion that last about 8 to 30 milliseconds. According to the type of chosen harmonization, the operating line moves in the compressor map. The operating line approaches or moves away from the surge line depending upon the compressor exit flow function. It might not be a single operating line but a field of operating lines, which are moving like those in the compressor map of turbocharged piston engines. The system allows a complete flexibility insofar as it is possible to modify the number of units of 3 operating chambers when the compressor air mass flow decreases for example. It can be decided to operate with 3 units from 5.

### 3. ARCHITECTURE

The Pulse Combustion Engine (PCE) can be compared to a conventional gas turbine except the pulse combustion chambers and the first turbine stages. The chambers are operating mainly transitorily and unsteady state. They generate pulses of gas at high temperature and pressure that are expanding in the turbine stages. Enveloped with a great density of isolation they are supposed adiabatic. The compressor is of conventional construction (axial, centrifugal, axially centrifugal or bi-centrifugal). The first high pressure turbine stages are equipped with Nozzle and turbine wheels adapted in order to take more in consideration the characteristic of the gas expansion pulses, action turbines or reaction turbines, axial or radials. A first supersonic turbine stage Nozzle is possible.

The shape of chambers can be cylindrical or spherical or others.

The shape of the turbine nozzles can be square, round or others.

### 3.1 INTERCOOLER

The addition of an intercooler (air/air or air/water or air/oil) is possible and increases the power of the engine by increasing the mass of air introduced in the chambers. If it is an aeronautic application the intercooler could use the “RAM effect” (recovery air Mach number).

### 3.2 COMBUSTION

It is constant volume combustion (isochore). In comparison with other thermodynamic cycles (iso-pressure, isothermal) with the same cycle area in the enthalpy—entropy diagram (that means: the same thermal energy quantity exchanged), the constant volume combustion changes the shape of the diagram cycle to raise the high pressure zones and thus reduces the relative increase of entropy. This improves the cycle efficiency and reduces the specific fuel consumption of the engines.

From a practical point of view the combustion operates in a conventional manner by central introduction and multi point of fuel and ignition of parking plugs by an appropriated electronic. It will be also possible to use the heat of residual gases of the previous gas expansion for the ignition of the fresh mixture of fuel and air. To permit the most complete combustion possible the injection system uses a fuel pump, which inject the fuel in the chamber at very high pressure (1000 bar (100 000 Kpa)—similar to HDI type system). This is to reduce the time period of injection and to guarantee the shortest fuel evaporation time.

These new quick injection elements are essential for the functioning of the Pulse Combustion Engine PCE.

### 3.3 WALL COOLING—WALL TEMPERATURE OF THE MATERIALS

It is possible to operate with a low fuel/air ratio (excess air). However to reach the most elevated pressures possible we research to operate at combustion temperature approaching the stoechiometric which is about 2500° K. with a temperature of fresh air at 700° K. (compressor exit) and a N2/O2 ratio of 3.76 (air ambient). It will be necessary to look for the transitory characteristics of the materials in order to determine the temperature function of the wall temperature Tp=f(fx) (function of the pulses frequency (fₓ)).

So a material able to operate at 800° K. in steady state conditions, should be able to operate at a temperature as much high as the pulse frequency is low. The phenomena of thermal skin effect has be taken into account and open a new field of exploration for the materials strains capabilities using oulsed frequency process.

### Piston Engines Cooling

The oil film covers the cylinder wall (inner side) of piston engines and aim to minimize works (losses) of friction of the piston segments, to improve the tightness and to evacuate partially heat in the oil. Therefore it is necessary to cool the cylinders (tubes, cylinder base gasket) with water or air to prevent a high oil consumption or carbon deposits. At the top of the combustion chamber itself and at a low height from the peak of the cylinder, the cooling is as much possibly minimized in order to conserve the heat because when the piston is at PMH (piston top position). The volume of the chamber doesn't need a very important cooling. The heads of the cylinder cooled by air are not very fanned. Sometimes an oil jet circulating through the crank arm is projected under the head of the piston to cool it, but this is used in very loaded engines.

It can be agreed that without any piston movement, it seems possible to operate constant volume combustion with a minimized cooling, nearly no cooling under the condition that it is a pulse combustion process that allows cooling time periods alternatively with hot combustion time periods. In an engine operating at 5000 RPM (12 ms for 1 revolution) the frequency of combustion is 42 Hz (a combustion every 2 revolutions).

However in a first time, the high-pressure turbine stages will have supplementary air-cooling flow. An air pump powered mechanically by the gas generator through adequate reduction gearbox will insure HP (high-pressure) Nozzle and turbine blades cooling. This air pump assist is necessary because the level of pressure of gas (50-60 Bars—5000-6000 Kpa) at the high-pressure turbine inlet (THP) is very superior to the compressor air pressure (15 Bars—1500 Kpa in our example). In the estimated performances cycles it has been supposed that the pump air mass flow equals about 10 % of the compressor air mass flow. (See chapter 5 estimated Performances).

The pulse discontinuity is not only temporal but also spatial insofar as one chamber of 3 will be in the gas expansion phase during a cycle of its unit. Thus in a PCE equipped with 15 chambers only 5 chambers will be in gas expansion phase at a time. The other chambers are either in air intake phase either in combustion phase. The study of unit harmonization shows the pulses lag. This means that the turbine blades could run some distance before seeing again a new pulse. To define it, it is necessary to know the gas generator shaft speed. From this point of view the pulse motor operating at 20 000 RPM seems more propitious for blade cooling purpose.

Note 1: Addition of a cooling and scavenging chamber

If the temperature levels of the inner sides of the chambers are too high it is possible to add a fourth scavenging/cooling chamber to the cycle. So we will obtain the following cycle; air intake, Combustion, Gas expansion, Cooling/scavenging. Then the engine will be equipped with units of 4,8, 12, 16 chambers or a multiple of the number 4. The obvious aim is to reduce their numbers.

### 3.4 QUICK OPENING AND CLOSING SYSTEMS OF THE CHAMBERS

(FIGS. 1 to 8). The combustion chambers air inlet and gas exits are controlled by systems of quick opening and closing (throttle valves, butterfly valves, overhead valves or forehead valves with chamfer). These systems are driven by powerful springs and Electro magnets of recall (electromagnet valves). These electromagnets are driven by a powerful electronic (42V) controlled by a digital system. This permits algorithms programming of valves opening and closing which can be independent of the engine speed shaft and of any other parameter.

### 3.4.1 VALVES (OR THROTTLE BUTTERFLY VALVES) AND RACK BAR

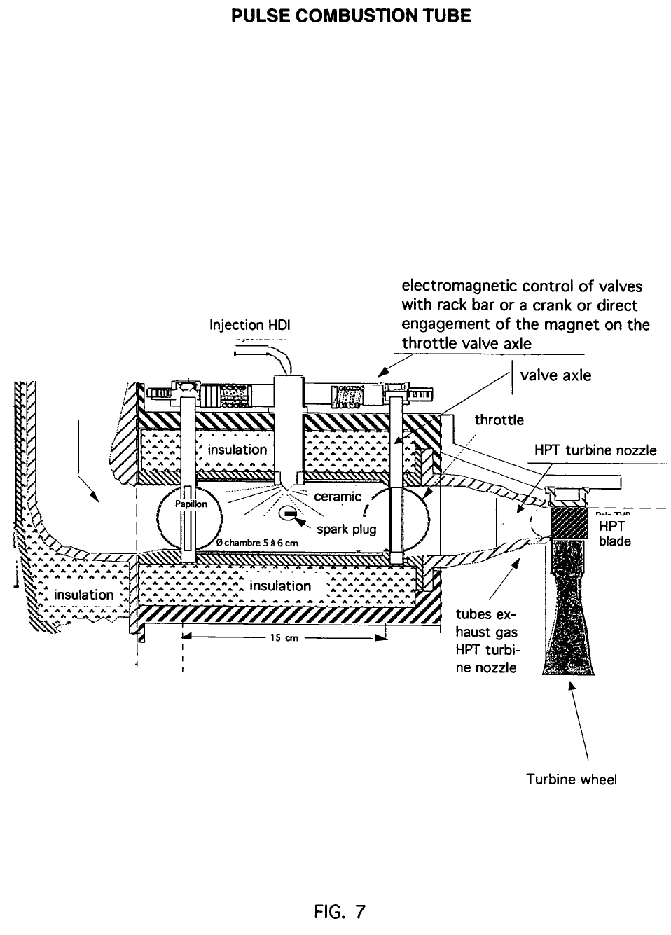

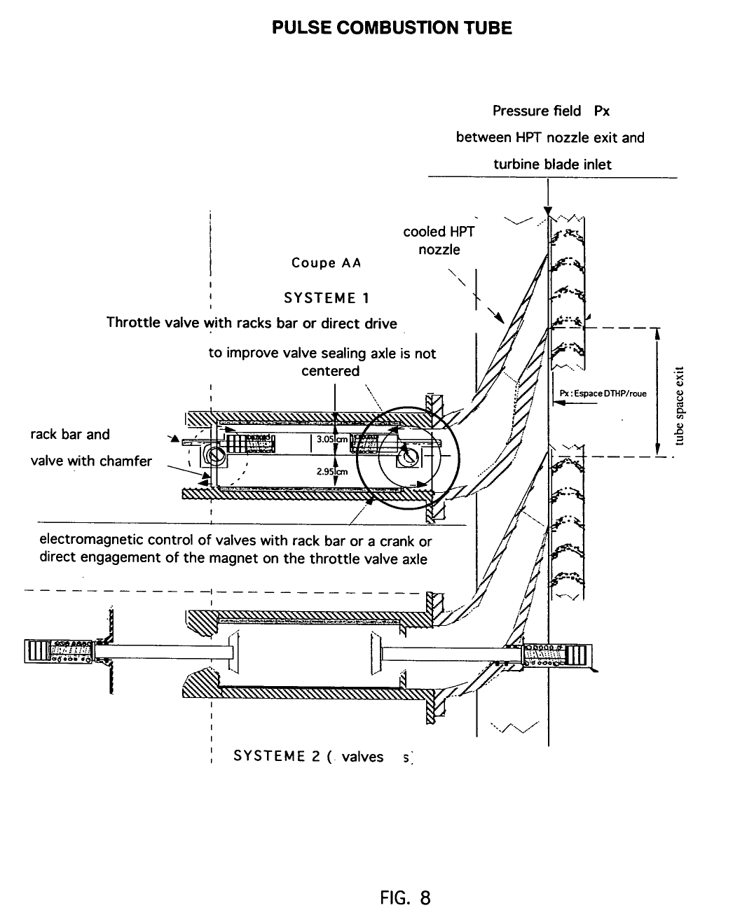

You can use butterfly valves (see FIGS. 7 and 8 herewith enclosed) with an axe lightly out of centerline in order to improve the air or gas tightness. The forces applied each side of the butterfly axle resulting from the differential pressure operated on the faces having not the same area will improve tightness. The difference of pressure created by the out of center will be nevertheless minimized to limit the efforts of the springs and the electromagnets in order to improve the acceleration of the butterfly valves opening and closing. With the rank bar (or a system crank arm/handle) you open and close the valves (throttle valves).

It is also possible to use the direct grip (engagement) of the axle rotation of the electromagnetic motor if its dimension permits it or if its torque motor is sufficiently important and quick. In this case the rack bar and pinion gear is not necessary and you can drive directly the butterfly valves.

The driving axe is linked to a spring which set the butterfly valves in a normally open position (NO).

An electromagnet driven by an electrical power device, monitored by a microprocessor, permits the opening and closing in operating with an adapted voltage (42 VDC for example). This system can be inverted if the speed of the electromagnet action is superior to the action of the spring. We must prefer the short opening times.

Note 2

It is possible to use a more conventional system of opening and closing. For example such head valves used in piston engine with electromagnetic motor or camshaft powered by an electric motor. However the effort required moving the valves, which comes from the high gas pressures inside the chamber, could make this type of design impossible to use and will require very powerful electromagnet or springs.

### 3.5 INSTATIONNARY (UNSTEADY-STATE) PRESSURE FIELD PX

The space (the THP volume located between the Nozzle exit and the inlet turbine wheel) will be adapted in such manner that the field of static local (Px) pressure cannot increase after a too important diffusion of the pressure wave. A static pressure field locally too important in this area (for example superior to 4 to 6 bars—400 to 600 Kpa) can decrease the gas expansion time of emptying the chambers (To increase the cycle frequency fx) but reduce the quantity of fresh and admissible air mass in the volume of the chamber. This is going to reduce the maximum pressure and therefore the power of the engine. During the spatial management of the gas expansions of the chambers we arrange that 2 chambers are not located one near the other but rather opposite at 180°. For example, if the chamber 1 of unit 1/5 is in an gas expansion phase, the next gas expansion chamber will be in the unit 3/5 and not the unit 2/5 in pour example of 5 units of 3 chambers. It can be possible that every burst of gas has a circular influence and that tangential gas flow (turning or fluctuating) in the space Nozzle/wheel of the turbine disturb a correct functioning. For this reason azimutal management of the burst of gas (pulse) seems necessary in such a way that they operate in sites distant the one from the other. This avoids to a chamber in the beginning of the gas expansion phase to meet a too elevated pressure field (by a precedent burst of gas/pulse) even if the field is not unsteady-state (non-stationary).

### 4.PRELIMINARY DESIGN

For a given engine power requirement, it exist a trade-off between the number of chambers and their size. A great number improve the torque regularity, increase the lightness of use (ex: at reduced power or defect functioning of the machine the stop of one unit is possible where the others are still operating). It improves probably the turbine efficiency (to compare with turbine efficiencies met currently in turbocharged piston engines at constant Pressure or with a pulse converter or multi pulse converter systems). The increasing of their number increases the realization costs. Also even with high temperature, it exists a optimal dimension of the valve (butterfly valve) in such a way that the time of opening and closing are the most low possible and in minimizing their masse and therefore minimizing the required power by the electromagnetic command. The masses of the valves must admit the acceleration rate similar to those met by the valves in piston engines.

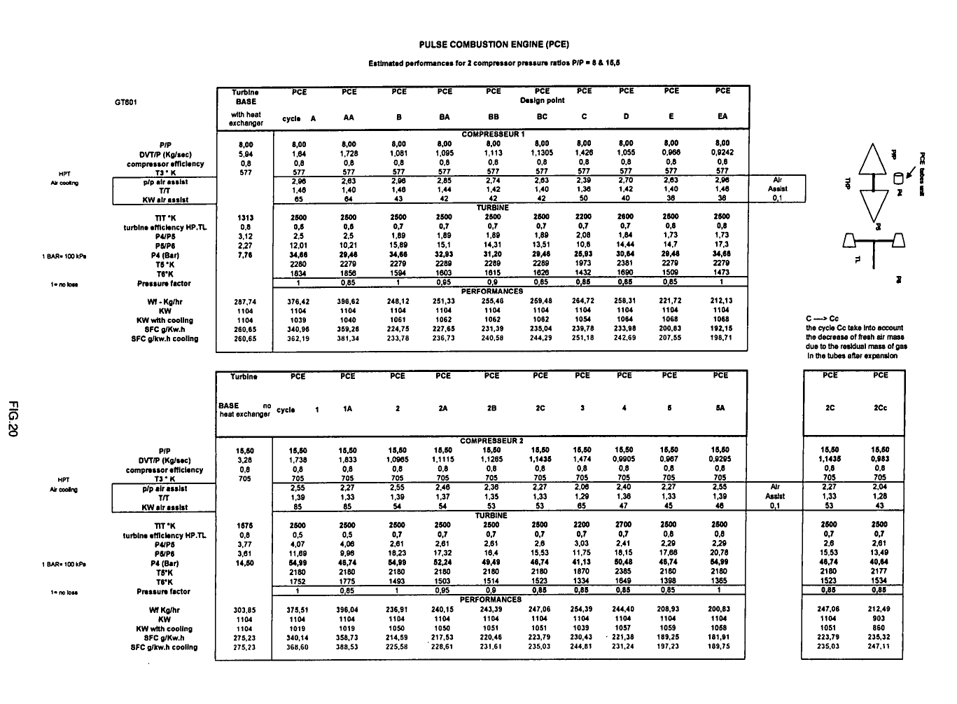

In a first row we have chosen as an example a prototype of a pulse combustion Engine (PCE) with 5 units of 3 chambers (15 chambers) and we have taken the cycle 2C as “design point” (see the chapter 5 estimated performances and the calculated cycles-FIG. 20).

### CYCLE 2C

Engine Power 1100 kW (1051 kW taking into account power requirement for air cooling) CSP=0.224 Kg/kw.h (0.235 kg/kw.h with air cooling) Turbine Isentropic efficiency=0.7

Compressor Pressure ratio P/P=15.5 & Air mass flow=1.131 Kg/sec Isentropic efficiency=0.80

PCE chamber Diameter (inside)=0.06 m Length=0.15 m—Volume 0.424 10⁻³ m³—Pressure coefficient=0.85—TET (Turbine inlet temperature)=2500° K.

We have chosen a cylindrical chamber that measures 0.15 m long and 0.06 m of diameter (0.424 10⁻³ m³). This diameter will be finalized during the experimental phase depending on the chamber feeding and the effects of possible gas compression (non-perfect gas).

At the operating point the air mass flow of 1.131 kg/sec corresponds to a flow volume of 0.146 m³/sec at chambers inlet. That is to say a flow volume (Dv) of 29.6 10⁻³ m³/sec per unit of 3 chambers (there are 5 units). The volume of a chamber is 0.424 liters, which corresponds to a functioning frequency of fₓᵢ (initial) of about 70 Hz (69.8 Hz). We have to fulfil a chamber 70 times per second. The calculated chamber cycle period is Tₓᵢ=14.32 milliseconds. In a unit of 3 chambers when one is in air intake phase of air the others cannot be in this phase, which means that the maximal time of air air intake must be less than 14.32/3=5 ms (that means f_{adm}=200 Hz).

With a pressure hypothesis of functioning at Pₓ=4 Bars−400 Kpa, the calculation gives the following results. (See FIG. 11)

Pₓ=4 Bars (400 Kpa)

M fresh air=0.0024 kg/chamber/tap

M total gas=0.00283 kg/chamber/tap

T_{adm}=8.022 ms

Tₓ(cycle)=15.772* ms *with hypotheses T_{comb}=3 ms

F_{adm}=125 Hz

F_{xc}=60 Hz (59.6) (calculated frequency)

Air mass flow=125×0.0024×5=1.5 kg/sec

This calculated air mass flow is greater than the required flow of 1.131 kg/sec

We notice that with a lower cycle (f_{xc}) and air intake (f_{adm}) frequency the pumped over air mass flow is greater than the required one. It is therefore necessary to reduce the size of the chamber or to reduce the number of units in such manner that there is convergence in such a way that f_{x calculated}=f_{xi initial}

Note:

In the tables herewith enclosed (FIG. 20) we notice the cycle 2 Cc. This is a correction of cycle 2C that takes into account the residual gas remaining in the chambers when in the gas expansion mode. The air replacement is not equal to 100% like we have supposed it initially (see detailed calculation in annex)

### 5. ESTIMATED PERFORMANCES

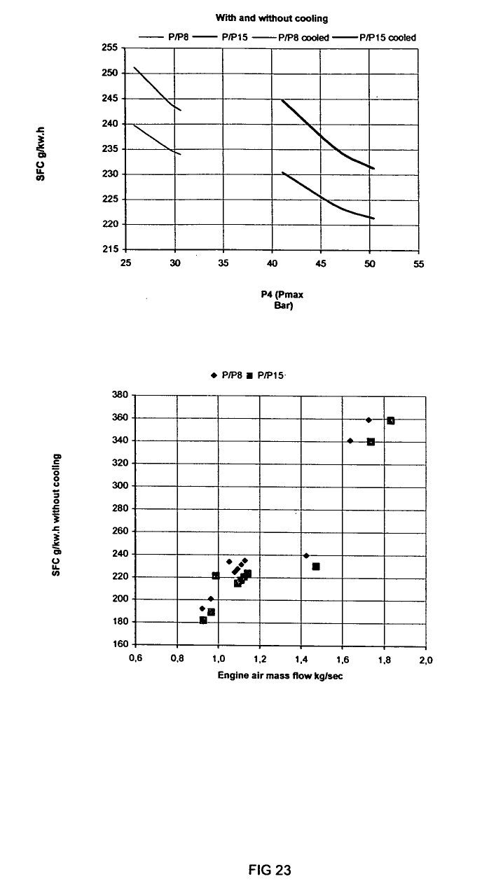

The FIGS. 20 and 23 herewith enclosed provide for the estimated performances for a PCE of 1100 kW and 2 compressor pressure ratios of P/P=8 and 15.5. The calculations use the usual enthalpy and entropy calculations methodology with the assumption of a gas molecules and atomic composition assuming no dissociation. Also turbine efficiency calculation in pulsing mode has been supposed having the same influence as the steady state mode (like in conventional gas turbine stages). In fact we have added the pressure factor to take into account the pressure losses due to non-perfect gas and others non-reversible losses. Also it should be noted that the literature indicates that gas turbines efficiency of 0.70 are currently met with turbines used in piston engine turbocharger which also operate with pressure waves. These 2 assumptions: the pressure factor and turbine efficiency similar to turbo-charger's one are 2 very conservatives hypothesis for performance calculation.

A study of sensibility has been made on the following parameters:

### 5.1 TURBINE EFFICIENCY

To evaluate the influence of the turbine efficiency (THP high-pressure turbine stage and TL free turbine): We supposed both THP and TL efficiencies were equal. The 3 held values are:

Turbine efficiency=ETAT=0.5−0.7 and 0.8

Notice: the literature admits currently an efficiency of 0.7 for turbines of piston engine turbocharger.

The use of turbocharger is more and more preponderant in piston engine and the correct efficiency (0.70) obtained is a proof that pulse gas turbines is possible. In piston engines numerous studies (ex: Pielstick-Sulzer etc.) have shown that more and more complicated systems: (pulse converter and multi pulse converter) improved the motor efficiency by improving the so-called “low pressure loop” of the engine cycle (emptying and fulfilling of the cylinder). This loop results essentially of its interaction with the turbocharger. The aims of these systems were to conserve the blast of emptying till his introduction in the turbine Nozzle. The turbocharger (called ‘at constant pressure” (a single recuperation collector) are in fact less efficient because or the pressure losses resulting from the diffusion in the collector and the losses of turbulence. The PCE permits to the burst of gas to act directly on the blades after a short distance (distance between the collector exit chamber and the HP turbine Nozzle inlet). This let's presage that PCE turbine to be more efficient turbines than those met in the piston engines turbocharger. We can interrogate ourselves on the possibility to use action turbine for the first turbine stages?

### 5.2 PRESSURE FACTOR EFFICIENCY

This is a coefficient to correct THP inlet pressure for non-perfect gas effects resulting of the combustion at constant volume, also it takes into account the valves pressure losses drop at the chamber inlet and outlet etc;. The 4 hold values for the sensibility studies are:

PRESSURE INDICATOR=1−0.95−0.90 and 0.85.

So a Pₘₐₓ=55 Bars (5500 Kpa) in the chamber gives a Inlet THP pressure of 46.75 bars with estimated losses of 15%.(coefficient 0.85)

### 5.3 TURBINE INLET TEMPERATURE (TIT)

The combustion temperature should be between 2400 and 2800° K. according to the level of fresh air, to the level of dissociation (peroxide NOx etc . . . ) and to the level of unburned particles resulting from a more or less imperfect combustion. The fuel flow calculations from the fuel/air ratio model in gas turbine are based on usual tables used for these calculations. This is not perfectly correct insofar as these calculations suppose combustion with constant pressure and not a constant volume like in the impulsion chamber.

The differences concern the calculations of enthalpy of reactions ΔH_{R} using the enthalpies of formation ΔH_{f} of species and not the internal energies of formations ΔU_{f}. This difference is less than 1% at 298° K.

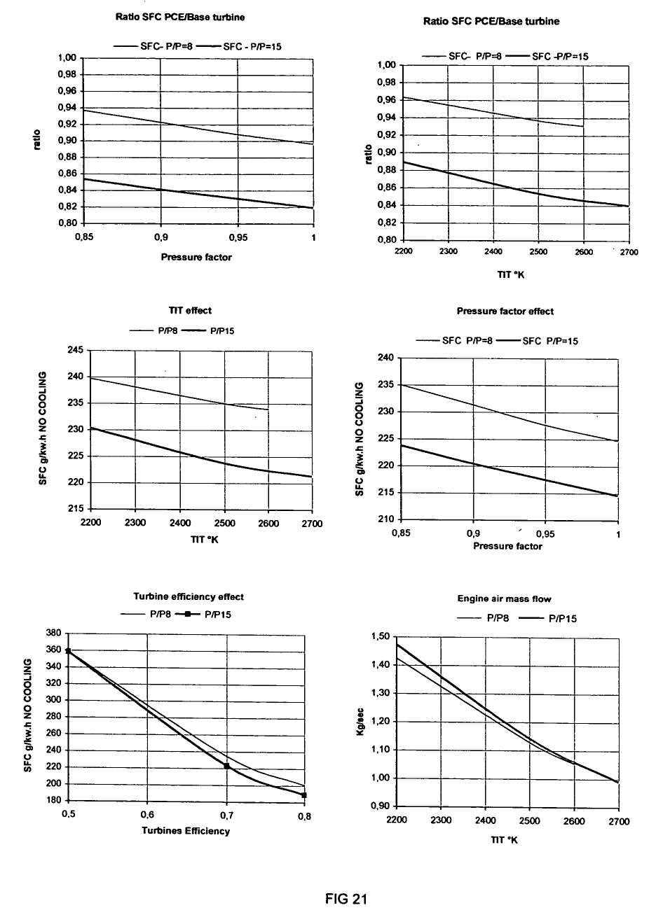

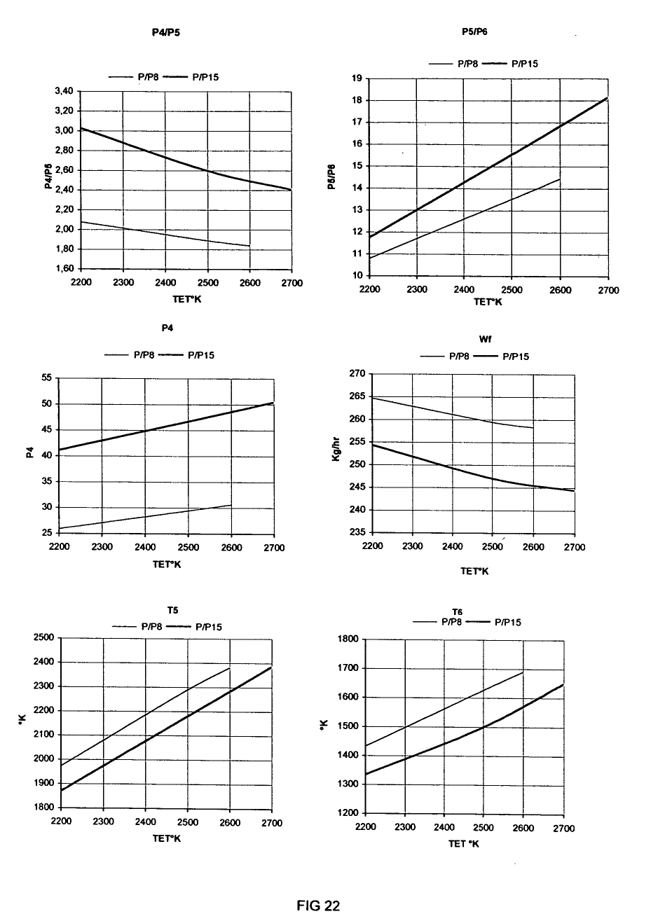

An error exists also for the calculations of enthalpy of reaction to the temperature of 298° K. instead of 2500° K. This error is also less than 1%. By the way it is currently neglected in the cycle calculations of the gas turbines. We have therefore studied the influence of combustion temperatures on the results of calculation of cycle for TET: 2200° K.—2500 and 2800° K. The FIGS. 20 to 23 herewith enclosed give the calculation results of the cycles.

### 6. CONCLUSIONS

With the conservative hypothesis (particularly about the turbine efficiency and the pressure factor) we note:

That with a turbine efficiency of 0.7, a production pressure factor at constant volume of 0.85 and a combustion temperature of 2500° K., the specific fuel consumption of the pulse combustion engine (PCE) are lower than that of the gas turbines fuel consumption including or not an heat exchanger.

The fuel consumption is similar or even lower than the piston engine's one.

The second advantage is, that at the same power level the air mass flow is very inferior to the one of a gas turbine (2 to 3 times lower). This reduces the dimension of turbo machines preserving the turbine advantage of steady state and not alternative functioning (vibrations, oil consumption, noise);

The turbine efficiency is a very determining parameter concerning the level of specific fuel consumption. It needs the study and the set up of turbine stages, capable to support a high TET and a high pressure with impulse. The study of sensibility shows that a specific fuel consumption of 179 to 186 g/kw.h can be obtained with turbine efficiency equals 0.80. This efficiency of 0.80 is usually reached in today's gas turbines technology.

The discontinuity introduced by the pulse rate and the impulse chambers permits the partial or defect functioning of the machine (by stopping one or several units). So the control is independent from a particular parameter. You can make function a determined number of chambers always at the maximum (for the maximal power) or at partial charge for the best efficiency (for the CSP mini).

According to the level of reliability, a pulse chamber can be developed and adapted to all kind of aeronautic, land or marine application. We see here the good impact on the recurrent costs and so the non-recurrent costs of setting up and development. It will be possible to increase the power of a machine by modifying the number of the unit of 3 chambers. You can imagine all a portfolio of power machines equipped by the same chamber but with a different number.

### Annex—Air Intake, Combustion and Expansion Cycle Calculation

A complete calculation of filling and emptying a combustion chamber (tube) should take into account the air and gas velocities distribution since momentum quantities associated to the local aerodynamic effects influence these air intake and gas expansion phases.

A preliminary estimation of the time period for filling and emptying a chamber- can be done from simple calculus if we suppose the law of perfect gas is applicable and in the filling phases if we suppose the mixture of residual gas and new fresh air is instantaneous and homogeneous. (No entropy increase, no turbulence)

P, T,m, Pressure, Temperature, Mass in the chamber. V volume of the chamber (constant)

Conservation of energy and mass and state equation at a given time t and at time t+dt give:

At the time t energy in the chamber is:

mCᵥT

During the time dt enter or leave the energies (Tc=compressor output temperature).

dmCₚT dmCₚT_{c}

At time t+dt we have in the chamber the energies (respectively for the filling and for the emptying)

(m+dm)Cᵥ(T+dT) (m−dm)Cᵥ(T−dT)

Thus the equations become (respectively for the filling and for the emptying)

mCᵥT+dmCₚT_{c}=(m+dm)Cᵥ(T+dT)

mCᵥT−dmCₚT=(m−dm)Cᵥ(T−d)

After differentiation and neglecting terms of second order we get (respectively for the filling and for the emptying)

$$\frac{dT}{T} = \frac{d m}{m} ( γ \frac{{T}_{c}}{T} - 1 ) \qquad \frac{dT}{T} = \frac{d m}{m} ( γ - 1 )$$

Perfect gas law gives with R=gas constant and V=constant (combustion chamber volume)

$$PV = mRT -> \frac{dP}{P} = \frac{d m}{m} + \frac{dT}{T}$$

Substituting dT/T in previous equation and differentiating with time we get (respectively for the filling and for the emptying)

P(t) instantaneous pressure in the chamber during filling (Tc=compressor or intercooler output temperature).

$$\frac{ⅆ P}{ⅆ t} = \frac{γ \cdot P}{m} \frac{{T}_{c}}{T} \frac{ⅆ m}{ⅆ t}$$

P(t) instantaneous pressure in the chamber during emptying (expansion).

$$\frac{ⅆ P}{ⅆ t} = \frac{γ \cdot P}{m} \frac{ⅆ m}{ⅆ t}$$

Then associating the following equations:

Air mass flow and m(t) instantaneous mass:

$$D = \frac{ⅆ m ( t )}{ⅆ t}$$

Air and gas corrected flow function versus static Mach number (M) at HPT (high pressure turbine) nozzle exit located after the combustion chamber—A=useful area (chamber air intake and turbine nozzle choked area). Corrected air/gas mass flow and instantaneous mass;

$${\begin{matrix}\frac{D \cdot \sqrt{T}}{P \cdot A} = \sqrt{\frac{γ}{R}} \cdot M \cdot [ 1 + \frac{γ - 1}{2} \cdot & {M}^{2}\end{matrix} ]}^{- \frac{γ + 1}{2 ( γ - 1 )}}$$

$$\frac{ⅆ m}{ⅆ t} = \frac{P \cdot A}{\sqrt{T}} \cdot \sqrt{\frac{γ}{R}} \cdot M \cdot {[ 1 + \frac{γ - 1}{2} \cdot {M}^{2} ]}^{- \frac{γ + 1}{2 ( γ - 1 )}}$$

P, total pressure at HPT inlet, (equal max pressure in the chamber times pressure factor losses-) Px=HPT nozzle exit pressure depending on local static field pressure located between HPT nozzle exit and turbine wheel.

$$\frac{P}{Px} = {[ 1 + \frac{γ - 1}{2} \cdot {M}^{2} ]}^{\frac{γ}{γ - 1}}$$

T, gas and air mixture Temperature during filling and/or emptying. Assumption instantaneous mixture. (Hypothesis gas specific heat Cp=cte.)

$${T}_{( t + 1 )} = \frac{{m}_{{( t )}_{residual - gas}} \cdot {T}_{{( t )}_{residual - gas}} + {m}_{{( t )}_{air}} \cdot {T}_{c}}{{m}_{{( t )}_{residual - gas}} + {m}_{{( t )}_{air}}}$$

Gas thermodynamics Characteristics.

$$γ = \frac{Cp}{Cv} R = Cp - Cv$$

Calculation is iterative and convergence happen when air mass volume ratio RHO calculated by 2 ways are equal and verify:

$$\begin{matrix}RHO = \frac{{P}_{( t )}}{{RT}_{( t )}} = \frac{{m}_{( t )}}{V} & V = constante & {\sum }_{i} d {m}_{i} = m\end{matrix}$$

### Iterations

A dtᵢₙᵢₜᵢₐₗ (fixed by assumption very small) allow calculation of dm/dt then dP/dt that give dP_{iterated} to be compared to a dPᵢₙᵢₕₜₐₗ (also fixed by assumption very small).

After calculation of P+dP (or P−dP for emptying), at T (n+1), and m+dm (or m−dm) allow checking:

P/RT>mN=RHO or P/RT<mN

Accordingly we increase by adequate dt and dP until convergence on RHO. That give dP_{final} and dm_{final}.

The perfect mixture (no turbulence, no entropy increase) of the residual mass of gas after expansion (emptying) and the new mass of fresh air entering in the chamber is a hypothesis allowing preliminary estimate of filling and emptying the combustion chamber for several hypothesis of Px=1,4,8 et 12 Bars. (1 Bar=100 Kpa)

### Performance Cycle

Fuel/air ratio model is used to estimate fuel consumption assuming no exhaust gas dissociation Nox (perfect combustion) Gas/Air Enthalpies and Entropies calculation use conventional polynomial forms:

$$\begin{matrix}H ( T ) = {\sum }_{n} {a}_{n} \cdot {T}^{n} & Hm ( T , {α}_{i} ) = \frac{{H}_{air} + {α}_{i} \cdot {H}_{kero}}{1 + {α}_{i}} & {α}_{i} = richesse = \frac{d c}{{D}_{i}} = \frac{carburant}{air} \\ φ ( T ) = {\sum }_{j} {a}_{j} \cdot {T}^{j} & \frac{{P}_{2}}{{P}_{1}} = {10}^{( {φ}_{2 is} - {φ}_{1} )} & φ ( T ) = {Log}_{10} exp ( {\int }_{0}^{T} \frac{Cp}{T} ⅆ T )\end{matrix}$$

1. Engines containing one or several axial and/or centrifugal compressors and one or several axial or radial turbine stages of which expansion can be by action or reaction, assembled on turning shafts and characterized by:
The fact that it includes one or several units of 3 or 4 combustion chambers operating at a fix or variable frequency and delivering gas bursts (pulses) to the turbines (action or reaction) stages after combustion has taken place at constant volume (isochore) in one or several units of three combustion chambers operating according to a three-phase cycle—intake, combustion, expansion for a unit of 3 chambers and with four-phases cycle—intake, combustion, scavenging/cooling—for a unit of 4 chambers where the phase of intake takes place in the first chamber while the phase of combustion takes place in the second chamber, while the phase of expansion takes place in the third chamber in an unit of three chambers, and the phases of scavenging takes place in the fourth chamber in an unit four chambers:

2. Engine according to claim 1 characterized by the fact that the opening and the closing of the chamber air intake and chamber exhausts operate from throttle valves (butterfly valves) powered by electromotors or electromagnets and recall springs through a rack or a rod system crank or a direct grip (engagement) on the rotation axe of the electromagnet.

3. Engine according to the claim 1 and 2 characterized by the fact that the shapes of the chambers are cylindrical or spherical or others.

4. Engine according to any claims 1 to 3, characterized by the fact that the throttle valves or the butterfly valves or the tightness valves of opening and closing of the chambers are chamfered and that the butterfly valves and the throttle valves have a guidance axe which is not centered in order to improve the tightness.

5. Engine according to the claim 1, characterised by the fact that material cooling in contact with hot gas uses the frequency regulation of gas bursts occurrences (pulses) and the mutual harmonization of units in order to permit times of successive cooling alternated with hot bursts which permits to increase the temperature of material use in contact with the hot gases.

6. Engine according to the claim 1, characterized by the fact that an assistant cooling air pump is added and powered by the motor shaft of the engine in order to cool the materials.

7. Engine according to any of the claims 1,5 and 6, characterized by the fact that the nozzles located at exit chambers are mono channel (one exit nozzle per chamber) or multi channel (several exits for one burst coming from the same chamber exit).

8. Engine according to any claims 1, 5, 6 and 7, characterized by the fact that the nozzles of turbine stages can be sonic or supersonic and have a shape squared, round or other.

9. Engine according to any of the claims 1 to 5, characterized by the fact that the engine control utilizes the pressure measures at chambers intake and exit and utilizes also the engine shaft speed and other parameters capable to be managed by a digital system and permitting numerous harmonization of the opening and closing times of the chambers and authorizing various permeability's and variable operating lines of in the compressor map.

10. Engine according to the claim 1, characterized by the fact that an exchanger (intercooler—air/air or air/water or air/oil) is inserted between the compressor air exit and the chamber air intake in order to improve the air fulfillment of the chambers.
